(19) United States
(12) Patent Application Publication
(10) Pub. No.: US 2023/0394408 A1
(43) Pub. Date: Dec. 7, 2023

(54) ROAD NETWORK OPERATION MANAGEMENT METHOD AND DEVICE, STORAGE MEDIUM, AND TERMINAL

(71) Applicants: China TransInfo Technology Co., Ltd., Beijing (CN); Beijing PalmGo Infotech Co., Ltd., Beijing (CN)

(72) Inventors: Shengmin GUO, Beijing (CN); Ruilong ZHANG, Beijing (CN); Hongyan MA, Beijing (CN); Chongxian SONG, Beijing (CN); Qiaowei NIE, Beijing (CN); Shudong XIA, Beijing (CN)

(73) Assignees: China TransInfo Technology Co., Ltd., Beijing (CN); Beijing PalmGo Infotech Co., Ltd., Beijing (CN)

(21) Appl. No.: 18/033,199

(22) PCT Filed: Oct. 21, 2021
(86) PCT No.: PCT/CN2021/125257

§ 371 Date: Apr. 21, 2023

(30) Foreign Application Priority Data
Oct. 23, 2020 (CN) 202011149756.4

(51) Int. Cl. G06Q 10/0633; G06T 11/20

(52) U.S. Cl. CPC G06Q 10/0633; G06T 11/206

(57) ABSTRACT

A road network operation management method and device, a storage medium, and a terminal. The method comprises: determining an analysis target on a road network to be managed, and extracting metadata of the analysis target; obtaining task data corresponding to the analysis target from a data table described by the metadata; preprocessing the task data corresponding to the analysis target on the road network on the basis of a received configured service processing rule to generate visual data corresponding to the analysis target on the road network; and performing rendering on the basis of the visual data corresponding to the analysis target on the road network to generate a visual element corresponding to the analysis target on the road network. The method can realize road network operation management and service platform data and service decoupling, improve the flexibility of data center service function extension.

### CROSS-REFERENCE TO RELATED APPLICATIONS

The present application claims priority to Chinese patent application No. 202011149756.4, titled “ROAD NETWORK OPERATION MANAGEMENT METHOD AND DEVICE, STORAGE MEDIUM, AND TERMINAL”, filed with the Chinese National Intellectual Property Administration on Oct. 23, 2020, the entire disclosure of which is incorporated herein by reference.

### TECHNICAL FIELD

The present disclosure relates to the technical fields of computer and intelligent traffic, and in particular to a road network operation management method and device, a storage medium, and a terminal.

### BACKGROUND

Road transportation plays an important role in China's economic and social development. Maintaining a stable and efficient operation of the road traffic network is of great significance for adjusting the industrial structure, promoting employment and economic development, and accelerating the process of urban-rural integration construction. In recent years, with the rapid growth of motor vehicle ownership and the gradual increase in road transportation demand, road traffic incidents occur from time to time and have a significant social impact. The operating pressure of maintaining a smooth operation of the road network is increasing, and it is urgent to design a method for effectively managing and serving the operation of the road network.

Road network operation management and services cover many business contents, including not only real-time perception and monitoring of road network operation situation, but also association analysis and mining of road network operation data, so as to meet diversified data support needs of road network operation management and public travel decision-making. The complexity of users, data and business in road network operational status monitoring is the main difficulty faced by road network operation management and service platform during the construction process. For example, from the roles, the users can be divided into ministerial leaders, road network operation monitoring personnel, road network operation analysts, and various types of travel groups, etc.; from the spatial attributes of customers, the users can be divided into ministerial level business personnel responsible for the operation of the national road network, provincial or municipal level business personnel responsible for the operation of provincial and municipal road networks, and frontline business personnel responsible for the operation of a single highway and a single toll station, etc. Different users have different requirements on data, service, and interaction. From the perspective of data, there are significant differences in the meaning, standards, and spatiotemporal expression of data collected by various types of traffic sensors, etc., which poses great challenges for fusion applications of data. From the perspective of business, in addition to regular monitoring tasks, there are also many temporary monitoring and data analysis tasks, such as road network operation emergencies, major activity safeguard and other tasks that need to be responded to and satisfied in a short time. To sum up, the complexity of users, data, and business has raised higher requirements on the generalization and expansion capabilities of the functions of the road network operation management and service platform, so it is necessary to achieve higher task flexibility to maintain the vitality of the platform.

In the construction process of road network operation management and service system, it is often only possible to start from the needs of a certain category of specific users and meet established road network operation monitoring or analysis tasks based on limited data resources. Whether from the perspective of users, data, or business, the ability to flexibly expand their tasks is weak in such systems, thus limiting the vitality of the road network operation management and service platform, and causing problems such as decentralized and repetitive construction of the system. Overall, the management information platform for China's road network operation has a low integration level, data has not yet been gathered, and barriers to various cross-region, cross-level, and cross-department information transmission, resource commonality and business linking are prominent. It is difficult to exert the overall efficacy of the road network operation, meet accurate services in transit, and ensure efficient emergency handling.

### SUMMARY

Embodiments of the present application provide a road network operation management method and device, a storage medium, and a terminal. In order to enable a basic understanding of some aspects of the disclosed embodiments, a brief summary is given below. This summary is not intended to be a general description, nor is it intended to identify key/important constituent elements or delineate the scope of protection of these embodiments. Its sole purpose is to present some concepts in a simple form as a prelude to the detailed description that follows.

In a first aspect, an embodiment of the present application provides a road network operation management method, which includes:
determining analysis targets on a road network to be managed, and extracting metadata corresponding to the analysis targets on the road network to be managed from a data center;
receiving configured data processing rules, and performing a query operation based on the data processing rules to acquire task data corresponding to the analysis targets on the road network to be managed from a data table described by the metadata;
receiving configured business processing rules, preprocessing the task data corresponding to the analysis targets on the road network to be managed according to the business processing rules, and generating visual data corresponding to the analysis targets on the road network to be managed; and
rendering based on the visual data corresponding to the analysis targets on the road network to be managed, and generating visual elements corresponding to the analysis targets on the road network to be managed.

Optionally, the visual elements include dynamic layer elements and chart set elements; and
after generating the visual elements corresponding to the analysis targets on the road network to be managed, the method further includes:
superimposing the dynamic layer elements through a GIS engine to generate a visual page corresponding to the analysis targets on the road network to be managed; or
integrating the chart set elements into a pre-generated management task analysis page to generate a visual page corresponding to the analysis targets on the road network to be managed; and
displaying the visual page corresponding to the analysis targets on the road network to be managed.

Optionally, the “rendering based on the visual data corresponding to the analysis targets on the road network to be managed and generating visual elements corresponding to the analysis targets on the road network to be managed” includes:
reading data rendering rules through a visualization engine;
rendering the visual data corresponding to the analysis targets on the road network to be managed according to the data rendering rules; and
generating the visual elements corresponding to the analysis targets on the road network to be managed.

Optionally, after generating the task data corresponding to the analysis targets on the road network to be managed, the method further includes:
sending the task data corresponding to the analysis targets on the road network to be managed to a table structure of a subject database of the task for saving.

Optionally, after generating the visual data corresponding to the analysis targets on the road network to be managed, the method further includes:
sending the visual data corresponding to the analysis targets on the road network to be managed to a table structure of a subject database of the task for saving.

Optionally, before determining the analysis targets on the road network to be managed, the method further includes:
receiving data processing rule configuration instructions;
acquiring a plurality of data processing rules corresponding to the data processing rule configuration instructions; in which the data processing rules include attribute fields required to be returned and query conditions; and
performing parameter configuration according to the attribute fields required to be returned and the query conditions to generate the configured data processing rules.

Optionally, before determining the analysis targets on the road network to be managed, the method further includes:
receiving business processing rule configuration instructions;
acquiring a plurality of business processing rules corresponding to the business processing rule configuration instructions; and
performing parameter configuration according to the plurality of business processing rules to generate the configured business processing rules.

In a second aspect, an embodiment of the present application provides a road network operation management device, which includes:
an analysis target determination module, which is configured to determine analysis targets on a road network to be managed, and extract metadata corresponding to the analysis targets on the road network to be managed from a data center;
a task data acquisition module, which is configured to receive configured data processing rules, and perform a query operation based on the data processing rules to acquire task data corresponding to the analysis targets on the road network to be managed from a data table described by the metadata;
a visual data generation module, which is configured to receive configured business processing rules, preprocess the task data corresponding to the analysis targets on the road network to be managed according to the business processing rules, and generate visual data corresponding to the analysis targets on the road network to be managed; and
a visual element generation module, which is configured to render based on the visual data corresponding to the analysis targets on the road network to be managed, and generate visual elements corresponding to the analysis targets on the road network to be managed.

In a third aspect, an embodiment of the present application provides a computer storage medium on which a plurality of instructions is stored, and the instructions are suitable for being loaded by a processor to execute the above method steps.

In a fourth aspect, an embodiment of the present application provides a terminal which can include a processor and a memory; in which a computer program is stored in the memory, and the computer program is suitable for being loaded by the processor to execute the above method steps.

The technical solutions provided by the embodiments of the present application can include the following advantageous effects.

In the embodiments of the present application, the road network operation management device first determines the analysis targets, and extracts the metadata corresponding to the analysis targets on the road network to be managed from the data center; then, it receives the configured data processing rules, and performs a query operation based on the data processing rules to acquire the task data corresponding to the analysis targets from the data center corresponding to the analysis targets; then, it receives the configured business processing rules, preprocesses the task data corresponding to the analysis targets on the road network to be managed according to the business processing rules, and generates the visual data corresponding to the analysis targets on the road network to be managed; finally, it renders based on the visual data corresponding to the analysis targets on the road network to be managed, generates the visual elements corresponding to the analysis targets on the road network to be managed, superimposes the dynamic layer elements through a GIS engine to generate a visual page corresponding to the analysis targets on the road network to be managed, or integrates the chart set elements into a pre-generated management task analysis page to generate a visual page corresponding to the analysis targets on the road network to be managed, and displays the visual page corresponding to the analysis targets on the road network to be managed.

The present application achieves unified operation and management of data by constructing a unified data center, thereby eliminating data barriers in informatization, and realizing decoupling and separation of road network traffic data and platform business functions. Through further abstraction and decomposition of business process, configuration generation for tasks is realized, and the flexibility of road network operation management and service platform task expansion are ensured. Further, the flexible expansion of tasks based on configuration has realized business evolution and accumulation of the platform. At the same time, task configuration schemes can also be accumulated, evolved and shared to help achieve rapid deployment and evolution of similar tasks.

It should be understood that the above general description and the following detailed description are only illustrative and explanatory, and do not limit the present disclosure.

### BRIEF DESCRIPTION OF THE DRAWINGS

The accompanying drawings herein are incorporated into the specification and constitute a part thereof. Embodiments according to the present disclosure are illustrated in the drawings, and are used together with the specification to explain the principles of the present disclosure.

FIG. 1 is a schematic flowchart illustrating a road network operation management method provided by an embodiment of the present application;

FIG. 2 is a schematic structural diagram of a data logic table of analysis targets on a road network to be managed in a data center provided by an embodiment of the present application;

FIG. 3 is a schematic diagram of a relationship model of the analysis targets on the road network to be managed within a road network operational status monitoring platform provided by an embodiment of the present application;

FIG. 4 is a schematic diagram of a business model of a road network operation management and service platform provided by an embodiment of the present application;

FIG. 5 is a schematic flowchart illustrating another road network operation management method provided by an embodiment of the present application;

FIG. 6 is a process block diagram of a road network operation management process provided by an embodiment of the present application;

FIG. 7 is a schematic device diagram of a road network operation management device provided by an embodiment of the present application; and

FIG. 8 is a schematic diagram of a terminal provided by an embodiment of the present application.

### DETAILED DESCRIPTION

Specific embodiments of the present disclosure will be fully illustrated in the following description and drawings to enable those skilled in the art to practice them.

It should be noted that the described embodiments are only some of the embodiments of the present disclosure, not all of them. Based on the embodiments in the present disclosure, all the other embodiments obtained by those skilled in the art without creative work will fall within the scope of protection of the present disclosure.

When the drawings are involved in the following description, unless otherwise indicated, the same numbers in different drawings denote the same or similar elements. The implementations described in the following exemplary embodiments do not represent all the implementations consistent with the present disclosure. On the contrary, they are only examples of systems and methods consistent with some aspects of the present disclosure, which are described in detail in the appended claims.

In the description of the present disclosure, it should be understood that the terms “first”, “second” and the like are used only for descriptive purposes and cannot be understood as indicating or implying relative importance. For those skilled in the art, the specific meaning of the above terms in the present disclosure can be understood according to specific circumstances. In addition, in the description of the present disclosure, unless otherwise indicated, “a plurality of” refers to two or more. “and/or” describes the association relationship of associated objects, indicating that there can be three relationships; for example, A and/or B can represent the following three situations: the existence of A alone, the simultaneous existence of A and B, and the existence of B alone. The character “I” generally indicates that the associated objects in front of and behind “/” are of an “or” relationship.

Due to the lack of a unified management method and system framework for road network operation, currently, in the construction process of road network operation management and service system, it is often only possible to start from the needs of a certain category of specific users and meet established road network operation monitoring or analysis tasks based on limited data resources. Whether from the perspective of users, data, or business, the ability to flexibly expand their tasks is weak in such systems, thus limiting the vitality of the road network operation management and service platform, and causing problems such as decentralized and repetitive construction of the system. Overall, the management information platform for China's road network operation has a low integration level, data has not yet been gathered, and barriers to various cross-region, cross-level, and cross-department information transmission, resource commonality and business linking are prominent. It is difficult to exert the overall efficacy of the road network operation, meet accurate services in transit, and ensure efficient emergency handling. For this purpose, the present application provides a road network operation management method and device, a storage medium, and a terminal, so as to solve the above problems existing in the related art. In the technical solutions provided by the present application, by constructing a unified data center, data barriers in informatization are eliminated, thus realizing decoupling and separation of road network traffic data and platform business functions, so that the efficiency of platform business functions in processing road network traffic data is greatly increased, and the management performance of road network operation is further improved. Exemplary embodiments will be used below for detailed description.

The road network operation management method provided by the embodiment of the present application will be described in detail below in connection with FIGS. 1 to 6. This method can be implemented by relying on a computer program and can be run on a road network operation management system which is based on the Von Neumann system. The computer program can be integrated into applications or run as a standalone tool class application.

Reference is made to FIG. 1, which is a schematic flowchart illustrating a road network operation management method provided by the embodiment of the present application. As shown in FIG. 1, the method of the embodiment of the present application can include the following steps S101 to S104.

S101: determining analysis targets on a road network to be managed, and extracting metadata corresponding to the analysis targets on the road network to be managed from a data center.

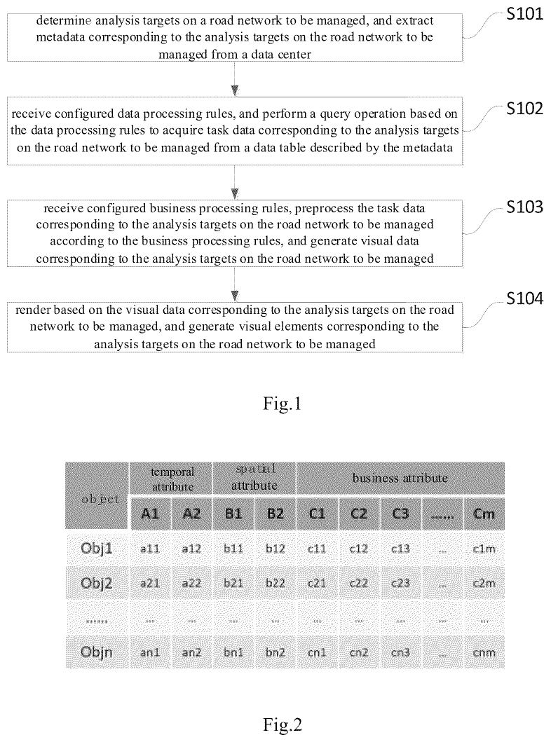

The analysis targets on the road network are one or more physical objects deployed on the road, such as toll stations, service areas, and road sections. The data center is a data processing module provided by the present application, which is configured to calculate common data indicators required for all businesses. The metadata is a description of data attributes of one or more analysis targets on the road network to be managed, such as temporal attribute, traffic attribute, etc. The data contents required for the analysis targets are organized into a data table in the form of a two-dimensional table based on each data attribute, as shown in FIG. 2. In the data center, the time, space and business attribute data of the analysis object are mainly calculated and stored. Due to the differences in the definitions of the time, space and business attribute data of each type of object, in the definition of the logic table structure of the data center, each type of object is defined and stored separately, thus forming a data storage result as shown in FIG. 2. The metadata is the description of each attribute in the header of the data table.

Generally, the abstract definition of analysis targets on the road network is a bridge for realizing decoupling of platform data and business logic in the management of road network operation. Within the data center, the present application can define and organize data based on the analysis targets on the road network. In business logic, the present application can achieve visual interaction of businesses around the analysis targets on the road network.

Specifically, when defining and organizing data based on the analysis targets on the road network, the analysis targets MapObject on the road network are defined as follows: mo= [symbol] id, type, P_{T}, P_{S}, P_{B}, Φ [symbol] , where id uniquely identifies one analysis target mo on the road network, type defines the type of the analysis target on the road network, P_{T} defines a temporal attribute set of the analysis target on the road network, P_{S} defines a spatial attribute set of the analysis target on the road network, P_{B} defines a business attribute set of the analysis target on the road network, and Φ={ϕ(mo)} defines a visualization method set of the analysis target on the road network.

In a possible implementation, when monitoring the current real-time status of one or more analysis targets on a specified road network, one or more analysis targets on the specified road network are first determined, and then Table metadata generated for the one or more analysis targets by preprocessing is acquired from the data center, that is, the description information of the attribute fields contained in the one or more analysis targets is acquired.

Further, when generating the Table metadata for the one or more analysis targets by preprocessing, operational status data of the current analysis target is first collected through sensing devices deployed on the one or more analysis targets (for example, the traffic data passing through the toll station per unit time is calculated based on an image collection device installed on the toll station), then the operational status data is divided into temporal attribute data, spatial location attribute data and business logic attribute data, and finally the data after completion of division is input into the Table data table in the data center.

S102: receiving configured data processing rules, and performing a query operation based on the data processing rules to acquire task data corresponding to the analysis targets on the road network to be managed from a data table described by the metadata.

The data processing rules can be configured by users after real-time setting according to the analysis targets on the current road network to be managed, or they can be data processing rules configured in advance by users. The configuration of rules is that users configure the rules according to the acquired metadata. The rules include configuration rules for attribute fields required to be returned when performing a lookup operation on the data table described by the metadata acquired in step S101, and condition configuration rules for the required query. The query operation is a select operation in which the system business logic performs database query according to the conditions configured by the user for the required query, or database query operation technologies such as a microservice query operation. The task data is a result data obtained after the business logic of the system performs the select operation or database query operation technologies such as the microservice operation.

In a possible implementation, when the metadata corresponding to the analysis targets on the road network to be managed is acquired based on step S101, the user enters the data processing rules for the client at this time, which include rules for attribute fields returned for the analysis targets and rules for filtering unnecessary fields. After receiving the configured data processing rules, the client uses the configured data processing rules as parameters for configuring a structured query language (SQL). After successful configuration, the configured structured query language is input into a searcher. After obtaining the structured query language corresponding to the analysis targets on the current road network to be managed, the searcher acquires the task data corresponding to the analysis targets on the road network to be managed from the metadata corresponding to the analysis targets according to the SQL statement.

In another possible implementation, when processing according to the data processing rules preconfigured by the user, after the metadata corresponding to the analysis targets on the road network to be managed is acquired based on step S101, the road network operation management device loads the data processing rules preconfigured for the analysis targets on the road network to be managed. After acquiring the preconfigured data processing rules, the road network operation management device uses the configured data processing rules as parameters for configuring the SQL. After successful configuration, the configured SQL is input into a searcher. After obtaining the structured query language corresponding to the analysis targets on the current road network to be managed, the searcher acquires the task data corresponding to the analysis targets on the road network to be managed from the metadata corresponding to the analysis targets according to the SQL statement.

Further, when preconfiguring the data processing rules, data processing rule configuration instructions are received first, and then a plurality of data processing rules corresponding to the data processing rule configuration instructions are acquired. The data processing rules include attribute fields required to be retuned and query conditions. Finally, parameter configuration is performed according to the attribute fields required to be retuned and the query conditions to generate preconfigured data processing rules.

For example, the analysis task on a certain road network is to monitor the real-time congestion and traffic conditions of all congested toll stations in the upgoing direction of the Beijing-Shanghai highway, which is equivalent to performing a SQL select (query) operation on the two-dimensional tables of the toll stations in the data center. First, based on the Table metadata of the toll station object, the description of attribute data related to all the toll stations is acquired, and then the returned attribute fields are configured. For example, in this task, the attributes of the toll stations, including name, location, congestion length and traffic value, are returned in real time. Then, query conditions are configured to filter out all the toll stations in the upgoing direction of the Beijing-Shanghai highway based on the highways to which the toll stations belong and upgoing and downgoing attributes. For example, if a toll station with a congestion length larger than 1000 meters is defined as a congested toll station, then the query condition will be defined as a congestion length attribute larger than 1000 meters (attribute), and the congested toll stations are filtered out. Finally, the configured conditions are submitted to the system, and the system will generate a periodical task. According to the configured conditions, the toll station data that meets the conditions will be extracted from the data center at regular time, and will be stored in the table structure of the subject database of the task.

Further, after completion of configuration, the configured conditions are submitted to the system, and the system will generate a periodical task. According to the configured conditions, the task data that meets the conditions will be extracted from the data center at regular time, and will be stored in the table structure of the subject database of the task. Setting the subject database of the task can, on one hand, avoid direct operation of the data center by the business system, and improve query and calculation efficiency; on the other hand, it can be used as an archive of task execution process data for facilitating review and retrieval after completion of the task.

S103: receiving configured business processing rules, preprocessing the task data corresponding to the analysis targets on the road network to be managed according to the business processing rules, and generating visual data corresponding to the analysis targets on the road network to be managed.

The business processing rules are to configure corresponding business modules to further deepen the processing of the task data generated by retrieval, so as to generate the data content required for visualization, such as simulation and prediction of data. It should be noted that the business modules are mainly customized and developed, which are summarized into a business library of the system for unified management.

Generally, in the embodiment of the present application, the analysis targets on the road network to be managed can be abstracted as a combination of several objects. For example, the national road network operation monitoring services include monitoring the operation situations of various provinces, various highways, and various toll stations, and the provinces, highways and toll stations are all the objects of monitoring. For another example, if the traffic situation of one highway is analyzed, then the toll station and tollgate associated with this highway will be used as the objects of analysis.

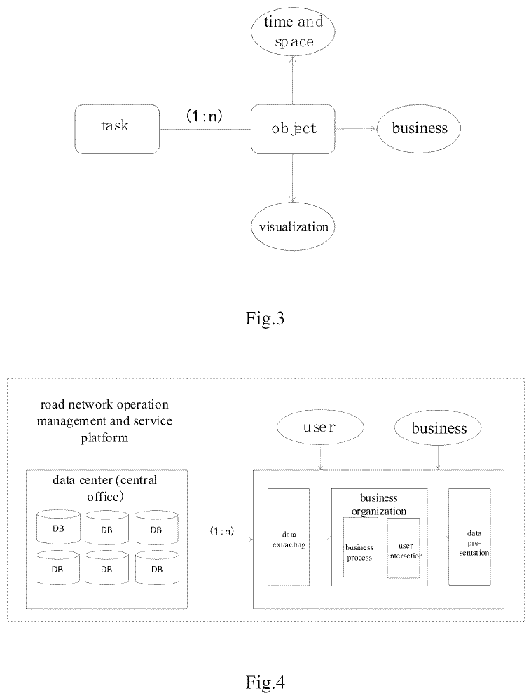

Further, by modeling the managed and analyzed road network objects (referred to as objects), they can be described by time and space attributes, business attributes and visualization attributes, as shown in FIG. 3. For example, for a toll station, the spatial attributes include, but are not limited to, the province to which it belongs, highway, segment, location and shape, etc.; the business attributes include, but are not limited to, incoming and outgoing traffic, the length of congestion queues, and the duration of passage, etc.; the visualization attributes define the visualization effects that can be presented around the type of toll station, including but not limited to the location and icon depicting the toll station on the GIS, which can be used to plot the range of congestion at the toll station, and plot thermodynamic chart and various charts according to the traffic situation of the toll station.

In a possible implementation, after obtaining the task data according to step S102, the user enters business processing rules according to the obtained task data. The rules are to further process and calculate data, such as simulation and prediction. After the client receives the input business processing rules, it preprocesses the task data corresponding to the analysis targets on the road network to be managed based on the received business processing rules, and generates visual data corresponding to the analysis targets on the road network to be managed.

In another possible implementation, after the task data is obtained according to step S102, the client automatically loads the business processing rules configured in advance by the user. After the client automatically loads the business processing rules configured in advance by the user, it preprocesses the task data corresponding to the analysis targets on the road network to be managed based on the business processing rules, and generates visual data corresponding to the analysis targets on the road network to be managed.

Further, when configuring the business processing rules in advance, the user first receives business processing rule configuration instructions, then acquires a plurality of business processing rules corresponding to the business processing rule configuration instructions, and finally configures parameters according to the plurality of business processing rules to generate preconfigured business processing rules.

Further, after the visual data corresponding to the analysis targets on the road network to be managed is generated, the visual data corresponding to the analysis targets on the road network to be managed is sent to the table structure of the subject database of the task for saving.

S104: rendering based on the visual data corresponding to the analysis targets on the road network to be managed, and generating visual elements corresponding to the analysis targets on the road network to be managed.

In data rendering, a visualization engine uses the visual data stored in the subject database of the task as an input to render and generate the visual elements of the analysis targets on the road network to be managed.

Generally, a possible rendering method is to generate layer elements of the analysis targets according to the visual data and location information of the analysis targets on the road network to be managed, or to draw a chart element according to the visual data for loading by the GIS engine, or to draw a graph element of traffic according to the traffic at the toll station for loading by an analysis task page.

It should be noted that the visualization definition is performed by selecting a preset visualization method and configured parameters for the visualization method.

In a possible implementation, when rendering the visual data corresponding to the analysis targets on the road network to be managed, the visual data is first acquired from a database (DB) of the task data corresponding to the analysis targets, and then the visual data corresponding to the analysis targets on the road network to be managed is rendered to generate visual elements corresponding to the analysis targets on the road network to be managed. The visual elements include dynamic layer elements and chart set elements. Finally, an analysis page defined by the front end assembles the visual elements according to the configurations defined by the business and built-in business interaction logics to generate visualization effects that can interact with users.

When the visual elements are dynamic layer elements, the dynamic layer elements are superimposed through the GIS engine to generate a visual page corresponding to the analysis targets on the road network to be managed.

When the visual elements are chart set elements, the chart set elements are integrated into a pre-generated monitoring task analysis page to generate a visual page corresponding to the analysis targets on the road network to be managed (the common form of which is the embedding of nine squares of the diagram) or to generate a report for downloading.

Further, the visual page corresponding to the analysis targets on the road network to be managed are finally displayed.

It should be noted that the assembly of visual elements can be defined and customized in advance according to the task type, and the visual elements of the analysis targets on different road networks to be managed are selected for integration. Therefore, the visual elements of the analysis targets on the road network to be managed need to be standardized and defined, so that they can be integrated into a visualization framework at the front end for display.

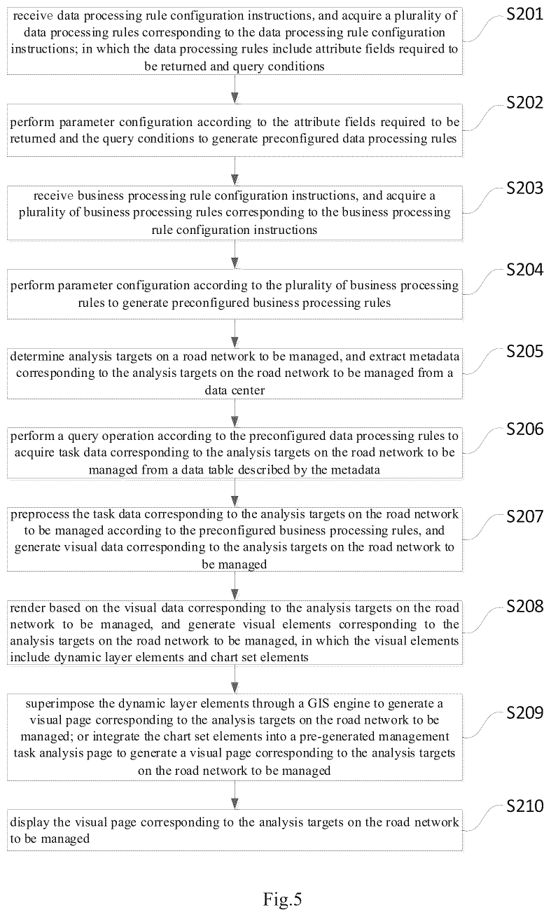

For example, as shown in FIG. 4, a business model of a road network operation management and service platform is provided by the embodiment of the present application, which can also be deemed as a management platform architecture for road network operation. This architecture is a combination of “fat central office+thin businesses”, in which a data center (central office) achieves the calculation of common data indicators required for all businesses. The business module is not responsible for the calculation of data indicators, but focuses on the implementation of business process, that is, it extracts and organizes the required data from the central office, calculates according to the business process, interacts with users, and ultimately presents the results of business to the users for view display. Through the construction of a unified data center (central office), not only decoupling of data and business is achieved, but also unified aggregation, unified integration, unified governance and unified operation of all input raw data on the platform are achieved, thereby eliminating the data barriers in the traditional informatization process.

In the embodiment of the present application, the road network operation management device first determines the analysis targets on the road network to be managed, and extracts the metadata corresponding to the analysis targets on the road network to be managed from the data center; then, it receives the configured data processing rules, and performs a query operation based on the data processing rules to acquire the task data corresponding to the analysis targets on the road network to be managed from the data table described by the metadata corresponding to the analysis targets; then, it receives the configured business processing rules, preprocesses the task data corresponding to the analysis targets on the road network to be managed according to the business processing rules, and generates the visual data corresponding to the analysis targets on the road network to be managed; finally, it renders based on the visual data corresponding to the analysis targets on the road network to be managed, and generates the visual elements corresponding to the analysis targets on the road network to be managed. By constructing a unified data center, data barriers in informatization are eliminated in the present application, thus realizing decoupling and separation of road network traffic data and platform business functions, so that the efficiency of platform business functions in processing road network traffic data is greatly increased, and the management performance of road network operation is further improved.

Reference is made to FIG. 5, which is a schematic flowchart illustrating another road network operation management method provided by an embodiment of the present application. As shown in FIG. 5, the method of the embodiment of the present application may include the following steps:
S201: receiving data processing rule configuration instructions, and acquiring a plurality of data processing rules corresponding to the data processing rule configuration instructions; in which the data processing rules include attribute fields required to be returned and query conditions;
S202: performing parameter configuration according to the attribute fields required to be returned and the query conditions to generate preconfigured data processing rules;
S203: receiving business processing rule configuration instructions, and acquiring a plurality of business processing rules corresponding to the business processing rule configuration instructions;
S204: performing parameter configuration according to the plurality of business processing rules to generate preconfigured business processing rules;
S205: determining analysis targets on a road network to be managed, and extracting metadata corresponding to the analysis targets on the road network to be managed from a data center;
S206: performing a query operation according to the preconfigured data processing rules to acquire task data corresponding to the analysis targets on the road network to be managed from a data table described by the metadata;
S207: preprocessing the task data corresponding to the analysis targets on the road network to be managed according to the preconfigured business processing rules, and generating visual data corresponding to the analysis targets on the road network to be managed;
S208: rendering based on the visual data corresponding to the analysis targets on the road network to be managed, and generating visual elements corresponding to the analysis targets on the road network to be managed, in which the visual elements include dynamic layer elements and chart set elements;
S209: superimposing the dynamic layer elements through a GIS engine to generate a visual page corresponding to the analysis targets on the road network to be managed; or integrating the chart set elements into a pre-generated management task analysis page to generate a visual page corresponding to the analysis targets on the road network to be managed; and
S210: displaying the visual page corresponding to the analysis targets on the road network to be managed.

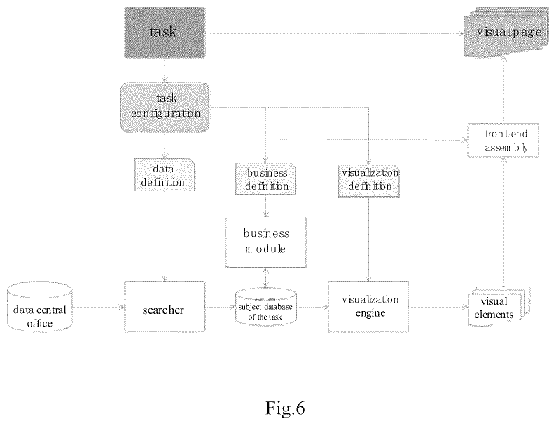

For example, reference is made to FIG. 6, which is a business process block diagram of road network operation management provided by the embodiment of the present application. For a given monitoring task or analysis task, task configuration is performed first, which includes data definition, business definition and visualization definition. In the data definition, the searcher first acquires task data of the analysis task in the data center according to the configured retrieval rules; in the business definition, the business module further deepens the processing of the task data generated by retrieval to generate data content required for visualization, such as simulating and predicting data; and in the visualization definition, the visualization engine uses the visual data stored in the subject database of the task as an input to render and generate the visual elements of the road network object; finally, the rendered visual elements are assembled through the front end to generate a visual page for display to the user.

In the embodiment of the present application, the road network operation management device first determines the analysis targets on the road network to be managed, and extracts the metadata corresponding to the analysis targets on the road network to be managed from the data center; then, it receives the configured data processing rules, and performs a query operation based on the data processing rules to acquire the task data corresponding to the analysis targets on the road network to be managed from the data table described by the metadata corresponding to the analysis targets; then, it receives the configured business processing rules, preprocesses the task data corresponding to the analysis targets on the road network to be managed according to the business processing rules, and generates the visual data corresponding to the analysis targets on the road network to be managed; finally, it renders based on the visual data corresponding to the analysis targets on the road network to be managed, and generates the visual elements corresponding to the analysis targets on the road network to be managed. By constructing a unified data center, data barriers in informatization are eliminated in the present application, thus realizing decoupling and separation of road network traffic data and platform business functions, so that the efficiency of platform business functions in processing road network traffic data is greatly increased, and the management performance of road network operation is further improved.

It should be noted that the numberings S201-S210 in the above steps are only for convenience of description, and do not necessarily indicate the sequence of various steps.

Described below is a device embodiment of the present disclosure, which can be used to execute the method embodiment of the present disclosure. For details not disclosed in the device embodiment of the present disclosure, reference may be made to the method embodiment of the present disclosure.

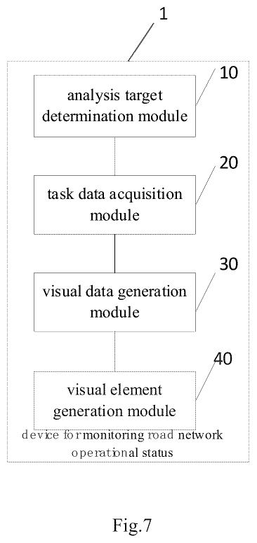

Reference is made to FIG. 7, which is a schematic structural diagram of a road network operation management device provided by an exemplary embodiment of the present disclosure. The road network operation management system can be realized as all or part of an intelligent robot through software, hardware, or a combination of both software and hardware. The device 1 includes an analysis target determination module 10, a task data acquisition module 20, a visual data generation module 30, and a visual element generation module 40.

The analysis target determination module 10 is configured to determine analysis targets on a road network to be managed, and extract metadata corresponding to the analysis targets on the road network to be managed from a data center.

The task data acquisition module 20 is configured to receive configured data processing rules, and perform a query operation based on the data processing rules to acquire task data corresponding to the analysis targets on the road network to be managed from a data table described by the metadata corresponding to the analysis targets.

The visual data generation module 30 is configured to receive configured business processing rules, preprocess the task data corresponding to the analysis targets on the road network to be managed according to the business processing rules, and generate visual data corresponding to the analysis targets on the road network to be managed.

The visual element generation module 40 is configured to render based on the visual data corresponding to the analysis targets on the road network to be managed, and generate visual elements corresponding to the analysis targets on the road network to be managed.

It should be noted that when the road network operation management method is executed by the road network operation management system provided by the above embodiment, only the division of the above functional modules is exemplified. In practical applications, the above functions can be allocated as required to different functional modules for completion, that is, the internal structure of the device can be divided into different functional modules to complete all or part of the functions described above. In addition, the road network operation management system provided by the above embodiment belongs to the same concept as the embodiment of the road network operation management method. For the implementation process thereof, detailed reference may be made to the method embodiment, and a repeated description will be omitted herein.

The serial numbers of the above embodiments of the present application are only for description and do not represent the advantages and disadvantages of the embodiments.

In the embodiment of the present application, the road network operation management device first determines the analysis targets on the road network to be managed, and extracts the metadata corresponding to the analysis targets on the road network to be managed from the data center; then, it receives the configured data processing rules, and performs a query operation based on the data processing rules to acquire the task data corresponding to the analysis targets on the road network to be managed from the data table described by the metadata corresponding to the analysis targets; then, it receives the configured business processing rules, preprocesses the task data corresponding to the analysis targets on the road network to be managed according to the business processing rules, and generates the visual data corresponding to the analysis targets on the road network to be managed; finally, it renders based on the visual data corresponding to the analysis targets on the road network to be managed, and generates the visual elements corresponding to the analysis targets on the road network to be managed. By constructing a unified data center, data barriers in informatization are eliminated in the present application, thus realizing decoupling and separation of road network traffic data and platform business functions, so that the efficiency of platform business functions in processing road network traffic data is greatly increased, and the management performance of road network operation is further improved.

The present disclosure also provides a computer-readable medium on which program instructions are stored, and when the program instructions are executed by a processor, the road network operation management methods provided by various method embodiments described above are implemented.

The present disclosure also provides a computer program product containing instructions, and when the instructions are run on a computer, the computer executes the road network operation management methods provided by various method embodiments described above.

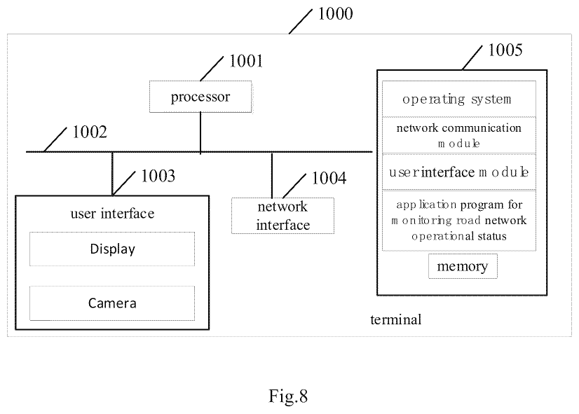

Reference is made to FIG. 8, which is a schematic structural diagram of a terminal provided by the embodiment of the present application. As shown in FIG. 8, the terminal 1000 may include at least one processor 1001, at least one network interface 1004, a user interface 1003, a memory 1005, and at least one communication bus 1002.

The communication bus 1002 is configured to achieve connection and communication between these components.

The user interface 1003 may include a display and a camera; optionally, the user interface 1003 may also include the standard wired interface and wireless interface.

Optionally, the network interface 1004 may include standard wired interface and wireless interface (such as WI-FI interface).

The processor 1001 may include one or more processing cores. The processor 1001 utilizes various interfaces and lines to connect various parts of the entire electronic device 1000, executes various functions of the electronic device 1000 and processes data by running or executing instructions, programs, code sets, or instruction sets stored in the memory 1005, and calling data stored in the memory 1005. Optionally, the processor 1001 can be implemented in hardware form of at least one of digital signal processing (DSP), field programmable gate array (FPGA), and programmable logic array (PLA). The processor 1001 can integrate one or a combination of central processing unit (CPU), graphics processing unit (GPU), modem and the like. The CPU mainly processes operating systems, user interfaces, and application programs; the GPU is responsible for rendering and drawing the content required to be displayed on the display; and the modem is configured to process wireless communication. It can be understood that the above modem can also be implemented by a single chip without being integrated into the processor 1001.

The memory 1005 may include random access memory (RAM) or read-only memory (ROM). Optionally, the memory 1005 includes a non-transitory computer-readable storage medium. The memory 1005 can be configured to store instructions, programs, codes, code sets, or instruction sets. The memory 1005 may include a storage program area and a storage data area; the storage program area may store instructions for implementing an operating system, instructions for at least one function (such as a touch control function, a sound playing function, an image playing function, and the like), instructions for implementing the above various method embodiments, and the like; the storage data area can store the data involved in the above various method embodiments. Optionally, the memory 1005 may also be at least one storage device located away from the above processor 1001. As shown in FIG. 8, as a computer storage medium, the memory 1005 may include an operating system, a network communication module, a user interface module, and an application for managing road network operation.

In the terminal 1000 shown in FIG. 8, the user interface 1003 is mainly configured to provide an interface for input by users to acquire data input by users; the processor 1001 can be configured to call the application for managing road network operation stored in the memory 1005, and specifically execute the following operations:
receiving a target monitoring task;
abstracting the target monitoring task and generating a monitoring directory;
adding a plurality of dynamic monitoring layers according to the monitoring directory; and
determining a visualization method for the monitoring layers based on the plurality of dynamic monitoring layers to achieve management of road network operation.

In an embodiment, the processor 1001 specifically executes the following operations when performing adding the plurality of dynamic monitoring layers according to the monitoring directory:
determining analysis targets on a road network to be managed, and extracting metadata corresponding to the analysis targets on the road network to be managed from a data center;
receiving configured data processing rules, and performing a query operation based on the data processing rules to acquire task data corresponding to the analysis targets on the road network to be managed from a data table described by the metadata;
receiving configured business processing rules, preprocessing the task data corresponding to the analysis targets on the road network to be managed according to the business processing rules, and generating visual data corresponding to the analysis targets on the road network to be managed; and
rendering based on the visual data corresponding to the analysis targets on the road network to be managed, and generating visual elements corresponding to the analysis targets on the road network to be managed.

In an embodiment, after performing generating the visual elements corresponding to the analysis targets on the road network to be managed, the processor 1001 further executes the following operations:
superimposing the dynamic layer elements through a GIS engine to generate a visual page corresponding to the analysis targets on the road network to be managed; or
integrating the chart set elements into a pre-generated management task analysis page to generate a visual page corresponding to the analysis targets on the road network to be managed; and
displaying the visual page corresponding to the analysis targets on the road network to be managed.

In an embodiment, when performing rendering based on the visual data corresponding to the analysis targets on the road network to be managed and generating visual elements corresponding to the analysis targets on the road network to be managed, the processor 1001 specifically executes the following operations:
reading data rendering rules through a visualization engine;
rendering the visual data corresponding to the analysis targets on the road network to be managed according to the data rendering rules; and
generating the visual elements corresponding to the analysis targets on the road network to be managed.

In an embodiment, after performing generating the task data corresponding to the analysis targets on the road network to be managed, the processor 1001 further executes the following operations:
sending the task data corresponding to the analysis targets on the road network to be managed to a table structure of a subject database of the task for saving.

In an embodiment, after performing generating the visual data corresponding to the analysis targets on the road network to be managed, the processor 1001 further executes the following operations:
sending the visual data corresponding to the analysis targets on the road network to be managed to a table structure of a subject database of the task for saving.

In the embodiment of the present application, the road network operation management device first determines the analysis targets on the road network to be managed, and extracts the metadata corresponding to the analysis targets on the road network to be managed from the data center; then, it receives the configured data processing rules, and performs a query operation based on the data processing rules to acquire the task data corresponding to the analysis targets on the road network to be managed from the data table described by the metadata corresponding to the analysis targets; then, it receives the configured business processing rules, preprocesses the task data corresponding to the analysis targets on the road network to be managed according to the business processing rules, and generates the visual data corresponding to the analysis targets on the road network to be managed; finally, it renders based on the visual data corresponding to the analysis targets on the road network to be managed, and generates the visual elements corresponding to the analysis targets on the road network to be managed. By constructing a unified data center, data barriers in informatization are eliminated in the present application, thus realizing decoupling and separation of road network traffic data and platform business functions, so that the efficiency of platform business functions in processing road network traffic data is greatly increased, and the management performance of road network operation is further improved.

It can be understood by skilled in the art that the implementation of all or part of the process in the methods of the above embodiments can be accomplished by instructing relevant hardware through a computer program, which can be stored on a computer-readable storage medium. When executed, the program may include processes of the embodiments of the various methods described above. The storage medium may be magnetic disk, optical disk, read-only storage memory, or random storage memory, etc.

Disclosed above are only preferred embodiments of the present application; of course, they cannot be used to define the scope of protection of the present application. Therefore, equivalent changes made in accordance with the claims of the present application still fall within the scope covered by the present application.

1. A road network operation management method, comprising:
determining analysis targets on a road network to be managed, and extracting metadata corresponding to the analysis targets on the road network to be managed from a data center;
receiving configured data processing rules, and performing a query operation based on the data processing rules to acquire task data corresponding to the analysis targets on the road network to be managed from a data table described by the metadata;
receiving configured business processing rules, preprocessing the task data corresponding to the analysis targets on the road network to be managed according to the business processing rules, and generating visual data corresponding to the analysis targets on the road network to be managed; and
rendering based on the visual data corresponding to the analysis targets on the road network to be managed, and generating visual elements corresponding to the analysis targets on the road network to be managed.

2. The method according to claim 1, wherein the visual elements comprise dynamic layer elements and chart set elements; and
after generating the visual elements corresponding to the analysis targets on the road network to be managed, the method further comprises:
superimposing the dynamic layer elements through a GIS engine to generate a visual page corresponding to the analysis targets on the road network to be managed; or
integrating the chart set elements into a pre-generated management task analysis page to generate a visual page corresponding to the analysis targets on the road network to be managed; and
displaying the visual page corresponding to the analysis targets on the road network to be managed.

3. The method according to claim 1, wherein the rendering based on the visual data corresponding to the analysis targets on the road network to be managed and generating visual elements corresponding to the analysis targets on the road network to be managed comprises:
reading data rendering rules through a visualization engine;
rendering the visual data corresponding to the analysis targets on the road network to be managed according to the data rendering rules; and
generating the visual elements corresponding to the analysis targets on the road network to be managed.

4. The method according to claim 1, wherein after generating the task data corresponding to the analysis targets on the road network to be managed, the method further comprises:
sending the task data corresponding to the analysis targets on the road network to be managed to a table structure of a subject database of the task for saving.

5. The method according to claim 1, wherein after generating the visual data corresponding to the analysis targets on the road network to be managed, the method further comprises:
sending the visual data corresponding to the analysis targets on the road network to be managed to a table structure of a subject database of the task for saving.

6. The method according to claim 1, wherein before determining the analysis targets on the road network to be managed, the method further comprises:
receiving data processing rule configuration instructions;
acquiring a plurality of data processing rules corresponding to the data processing rule configuration instructions; wherein the data processing rules comprise attribute fields required to be returned and query conditions; and
performing parameter configuration according to the attribute fields required to be returned and the query conditions to generate the configured data processing rules.

7. The method according to claim 1, wherein before determining the analysis targets on the road network to be managed, the method further comprises:
receiving business processing rule configuration instructions;
acquiring a plurality of business processing rules corresponding to the business processing rule configuration instructions; and
performing parameter configuration according to the plurality of business processing rules to generate the configured business processing rules.

8. The method according to claim 1, wherein the analysis target is mo= [symbol] id, type, P_{T}, P_{S}, P_{B}, Φ [symbol] , where id uniquely identifies one analysis target mo on the road network, type is the type of the analysis target, P_{T} is a temporal attribute set of the analysis target, P_{S} is a spatial attribute set of the analysis target, P_{B} is a business attribute set of the analysis target, and Φ={ϕ(mo)} is a visualization method set of the analysis target.

9. The method according to claim 1, wherein before determining the analysis targets on the road network to be managed, the method further comprises:
collecting operational status data of the analysis targets; dividing the operational status data into temporal attribute data, spatial location attribute data and business logic attribute data; and inputting the data after completion of the division into a Table data table in the data center.

10. The method according to claim 1, wherein the performing a query operation based on the data processing rules to acquire task data corresponding to the analysis targets on the road network to be managed from a data table described by the metadata comprises:
using the configured data processing rules as parameters for configuring a structured query language; after successful configuration, inputting the configured structured query language into a searcher; and the searcher acquiring the task data corresponding to the analysis targets on the road network to be managed from the metadata corresponding to the analysis targets according to the structured query language.

11. The method according to claim 1, wherein the configured data processing rules are generated according to the following steps which comprise:
receiving data processing rule configuration instructions; acquiring a plurality of data processing rules corresponding to the data processing rule configuration instructions, wherein the data processing rules comprise attribute fields required to be returned and query conditions; and performing parameter configuration according to the attribute fields required to be returned and the query conditions to generate preconfigured data processing rules.

12. The method according to claim 1, wherein the business processing rules are generated according to the following steps which comprise:
receiving business processing rule configuration instructions; acquiring a plurality of business processing rules corresponding to the business processing rule configuration instructions; and performing parameter configuration according to the plurality of business processing rules to generate preconfigured business processing rules.

13. The method according to claim 1, wherein the visual elements of the analysis targets on the road network to be managed are rendered and generated according to the following steps which comprise:
a visualization engine using the visual data stored in a subject database of the task as an input to render and generate the visual elements of the analysis targets on the road network to be managed.

14. The method according to claim 1, wherein the rendering based on the visual data corresponding to the analysis targets on the road network to be managed comprises:
acquiring the visual data from a database of the task data corresponding to the analysis targets, and then rendering the visual data corresponding to the analysis targets on the road network to be managed to generate visual elements corresponding to the analysis targets on the road network to be managed, wherein the visual elements comprise dynamic layer elements and chart set elements.

15. The method according to claim 1, wherein after acquiring the visual elements, the method further comprises:
when the visual elements are dynamic layer elements, superimposing the dynamic layer elements through a GIS engine to generate a visual page corresponding to the analysis targets on the road network to be managed; and
when the visual elements are chart set elements, integrating the chart set elements into a pre-generated monitoring task analysis page to generate a visual page corresponding to the analysis targets on the road network to be managed or to generate a report.

16. The method according to claim 1, wherein the rendering method comprises generating layer elements of the analysis targets according to the visual data and location information of the analysis targets on the road network to be managed for loading by a GIS engine.

17. The method according to claim 1, wherein the rendering method comprises drawing a chart element according to the visual data for loading by an analysis task page.

18. The method according to claim 1, wherein the data processing rules comprise rules for attribute fields returned for the analysis targets and rules for filtering unnecessary fields.

19. A road network operation management device, comprising:
an analysis target determination module, which is configured to determine analysis targets on a road network to be managed, and extract metadata corresponding to the analysis targets on the road network to be managed from a data center;
a task data acquisition module, which is configured to receive configured data processing rules, and perform a query operation based on the data processing rules to acquire task data corresponding to the analysis targets on the road network to be managed from a data table described by the metadata;
a visual data generation module, which is configured to receive configured business processing rules, preprocess the task data corresponding to the analysis targets on the road network to be managed according to the business processing rules, and generate visual data corresponding to the analysis targets on the road network to be managed; and
a visual element generation module, which is configured to render based on the visual data corresponding to the analysis targets on the road network to be managed, and generate visual elements corresponding to the analysis targets on the road network to be managed.

20. (canceled)

21. A terminal, comprising a processor and a memory; wherein a computer program is stored in the memory, and the computer program is suitable for being loaded by the processor to execute the steps of the method according to claim 1.
